(19) United States
(12) Patent Application Publication
(10) Pub. No.: US 2004/0005005 A1
(43) Pub. Date: Jan. 8, 2004

(54) Method and apparatus to facilitate image difference transmission while maintaining image salience

(76) Inventors: Kristen A. McIntyre, Fremont, CA (US); David M. Ungar, Mountain View, CA (US)

Correspondence Address: PARK, VAUGHAN & FLEMING LLP, 508 SECOND STREET, SUITE 201, DAVIS, CA, 95616, US

(21) Appl. No.: 10/420,231

(22) Filed: Apr. 21, 2003

Related U.S. Application Data
(60) Provisional application No. 60/374,378, filed on Apr. 22, 2002.

(51) Int. Cl. H04N 7/173; H04B 1/66; H04N 7/12; H04N 11/02; H04N 11/04

(52) U.S. Cl. 375/240.19; 725/90; 375/240; 375/240.18

(57) ABSTRACT

One embodiment of the present invention provides a system to facilitate image difference transmission for images in a video system. The system operates by receiving a video stream that includes a sequence of images. The system transforms a first frame of the sequence of images using a transform function to create a first transformed image. Note that this transform function places the image salience in the larger coefficients. The system also transforms a second frame using the same transform function to create a second transformed image. The system then subtracts the second transformed image from the first transformed image to create a difference-transformed image. The coefficients are arranged in order of size, from larger to smaller. Smaller coefficients, that are less than a specific threshold, are removed from the difference-transformed image so that this difference-transformed image can be stored and transmitted with reduced bandwidth while maintaining image salience.

### BACKGROUND

1. Field of the Invention

The present invention relates to video systems. More specifically, the present invention relates to a method and an apparatus that facilitates image difference transmission between video systems while maintaining image salience.

2. Related Art

Modern video systems, which transmit images from a video generating site to a video display site, typically use data compression techniques to reduce the bandwidth of the transmitted video stream. These video streams can include pictures generated by a camera, and three-dimensional renderings generated by a computer aided design (CAD) system.

Compressing a sequence of images, which comprise successive frames in a digitally encoded movie, often involves a technique that compares a given frame with the immediately preceding frame. If these frames are similar, only those areas within the frames that are different are compressed and made part of the compressed data stream. Periodically, a “key-frame,” which is not a difference from the prior frame, may be sent to reduce accumulated error.

FIG. 1 illustrates the process of transmitting video difference. In this process, subtracter 106 takes the difference, pixel-by-pixel, between second image 104 and first image 102 to create difference 108. Difference 108 is typically processed by codec 110 in which the signal is compressed to reduce the bandwidth of difference 108. The output of codec 110 is then sent to the display portion of the video system as a received difference 112. Note that received difference 112 can be sent through a network such as the Internet, or stored on a storage device for later delivery to the display system.

At the display system, adder 116 adds received difference 112 to reconstructed first image 114 to form reconstructed second image 118. Reconstructed image 118 is then saved to process the next image. Note that initially, and periodically thereafter, a key-frame is sent to prevent accumulation of errors.

A significant problem with this method is that the compression degrades salient portions of the video image in a way that is discernable by the human visual system. This degradation can cause portions of the image to be changed so that the image no longer represents the original.

What is needed is a method and an apparatus that facilitates image difference transmission that does not have the problems identified above.

### SUMMARY

One embodiment of the present invention provides a system to facilitate image difference transmission for images in a video system. The system operates by receiving a video stream that includes a sequence of images. The system transforms a first frame of the sequence of images using a transform function to create a first transformed image. Note that this transform function places the image salience in the larger coefficients. The system also transforms a second frame using the same transform function to create a second transformed image. The system then subtracts the second transformed image from the first transformed image to create a difference-transformed image. The coefficients are arranged in order of size, from larger to smaller. Smaller coefficients, that are less than a specific threshold, are removed from the difference-transformed image so that this difference-transformed image can be stored and transmitted with reduced bandwidth while maintaining image salience.

In one embodiment of the present invention, the system communicates the difference-transformed image to an image reconstructor. At the image reconstructor, the first transformed image is added to the difference-transformed image to create a reconstructed transformed image. An inverse transform function is then performed on the reconstructed transformed image to create a reconstructed second frame.

In one embodiment of the present invention, the reconstructed second frame does not exhibit visual degradation to a human visual system.

In one embodiment of the present invention, communicating the difference-transformed image to the image reconstructor involves communicating the difference-transformed image through a storage medium.

In one embodiment of the present invention, communicating the difference-transformed image to the image reconstructor involves communicating the difference-transformed image across a network.

In one embodiment of the present invention, the network includes the Internet.

In one embodiment of the present invention, the transform function is a discrete wavelet transform function.

In one embodiment of the present invention, the sequence of images includes a stream of pictures or a stream of three-dimensional renderings.

### BRIEF DESCRIPTION OF THE FIGURES

FIG. 1 illustrates a video difference transmission process.

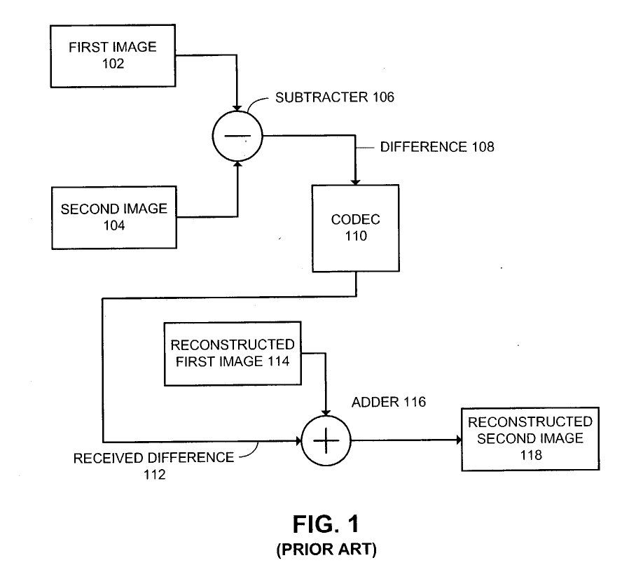

FIG. 2 illustrates video difference transmission in accordance with an embodiment of the present invention.

FIG. 3 illustrates video systems in accordance with an embodiment of the present invention.

FIG. 4 is a flowchart illustrating the process of creating and transmitting video differences in accordance with an embodiment of the present invention.

FIG. 5 is a flowchart illustrating the process of receiving video differences and displaying video images in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Video Difference Transmission

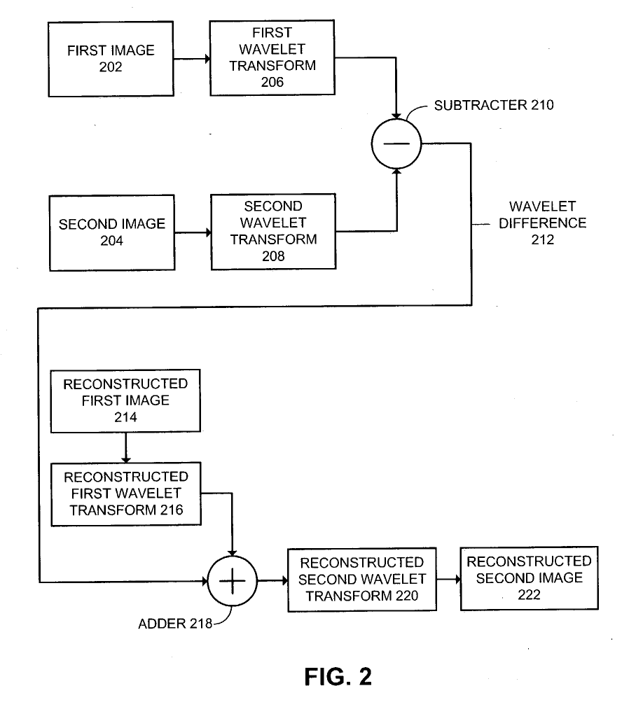

FIG. 2 illustrates operating of a system that performs video difference transmission in accordance with an embodiment of the present invention. During operation of the system, first image 202 and second image 204 of a video stream are transformed by a discrete wavelet transform (DWT) into a first wavelet transform 206 and a second wavelet transform 208, respectively. These wavelet transforms include coefficients of the basis functions used for the transform. Subtracter 210 subtracts second wavelet transform 208 from first wavelet transform 206 creating wavelet difference 212. Note that because of characteristics of the human visual system, some of the smaller—less important—coefficients can be discarded to save bandwidth without losing salience in a reconstructed image. Salience, in the context of a video image, refers to the parts of the video image that are interesting to the eye.

Wavelet difference 212 can be transmitted to an image reconstructor for reconstruction and display. Note that transmitting wavelet difference 212 to the image reconstructor can include using a network such as the Internet or can include storing wavelet difference 212 for later reconstruction.

At the image reconstructor, the system performs a DWT on reconstructed first image 214 to create reconstructed first wavelet transform 216. Note that reconstructed first image 214 can be a key frame sent through the system or can be a reconstruction of a previous image.

Adder 218 adds wavelet difference 212 to reconstructed first wavelet transform 216 to create reconstructed second wavelet transform 220. The system then performs an inverse DWT to create reconstructed second image 222. Reconstructed second image 222 can then be displayed on any suitable display device. Reconstructed second image 222 can also be saved to become reconstructed first image 214 for a subsequent image.

Video Systems

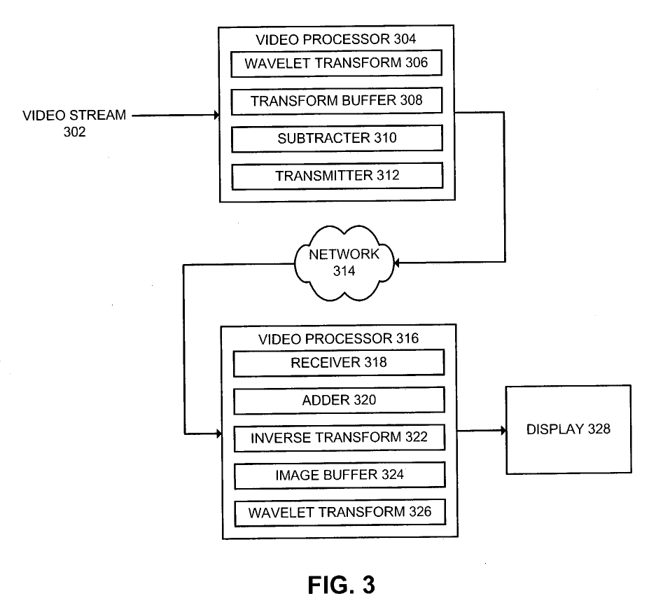

FIG. 3 illustrates video systems in accordance with an embodiment of the present invention. The system includes video processors 304 and 316 and display 328. Video processors 304 and 316 can generally include any type of computer system, including, but not limited to, a computer system based on a microprocessor, a mainframe computer, a digital signal processor, a portable computing device, a personal organizer, a device controller, and a computational engine within an appliance. Display 328 can include any device suitable for displaying video images.

Video processor 304 can be coupled to video processor 316 by several methods. One method is to use network 314. Network 314 can generally include any type of wire or wireless communication channel capable of coupling together computing nodes. This includes, but is not limited to, a local area network, a wide area network, or a combination of networks. In one embodiment of the present invention, network 314 includes the Internet. Another possible method is to route data from video processor 304 into a storage device for later recall by video processor 316.

Video processor 304 includes wavelet transform 306, transform buffer 308, subtracter 310, and transmitter 312. Wavelet transform 306 performs a discrete wavelet transform (DWT) on incoming frames of video within video stream 302. Note that wavelet transform 306 can be replaced by any transform, which has the property of including salient portions of the image in the larger coefficients. The output of wavelet transform 306 is stored in transform buffer 308.

Transform buffer includes sufficient storage to store at least two frames of video transform—the current frame and the previous frame. The individual frame buffers can be swapped for alternate frames of video so that the system always has the current frame and the previous frame.

Subtracter 310 subtracts the previous frame transform from the current frame transform to provide a difference between the two transforms. Additionally, subtracter 310 can remove smaller coefficients, which do not contribute to image salience.

Transmitter 312 sends the difference coefficients of the DWT to video processor 316. This transmission can occur over network 314, or alternatively can occur through a storage device where video processor 316 receives the difference coefficients at a later time.

Video processor 316 includes receiver 318, adder 320, inverse transform 322, image buffer 324, and wavelet transform 326. Receiver 318 receives the wavelet transform coefficients from transmitter 312 either across network 314 or from the storage device where transmitter 312 sent them.

Wavelet transform 326 performs a DWT on the reconstructed first image from image buffer 324 to create a reconstructed first wavelet transform. The reconstructed first image can be a key frame sent by video processor 304 or can be a reconstructed image for the preceding frame.

Adder 320 adds the reconstructed first wavelet transform to the wavelet difference from video processor 304 to create reconstructed second wavelet transform 220. Finally, inverse transform 322 performs an inverse DWT on reconstructed second wavelet transform 220 to create reconstructed second image 222. Reconstructed second image 222 is displayed on display 328 and is saved in image buffer 324. Image buffer 324 includes storage for at least two images—the current image and the preceding image. Typically, the image buffer space is swapped after each frame.

Creating a Transformed Data Stream

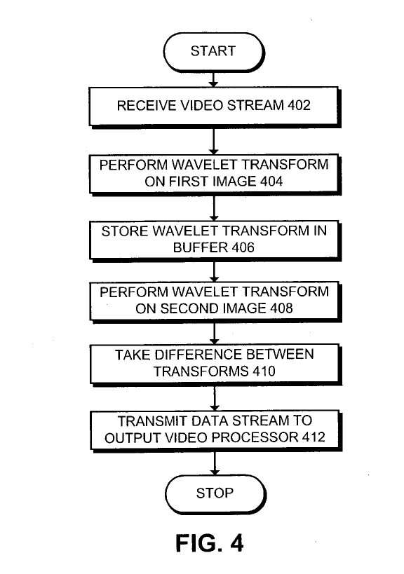

FIG. 4 is a flowchart illustrating the process of creating and transmitting video differences in accordance with an embodiment of the present invention. The system starts when video processor 304 receives video stream 302 (step 402). Next, wavelet transform 306 performs a discrete wavelet transform (DWT) on the first image of video stream 302 (step 404). Video processor 304 then stores the DWT coefficients in transform buffer 308 (step 406). Note that these DWT coefficients can be sent to video processor 316 as a key frame as described above.

Wavelet transform 306 then performs a DWT on the next image within video stream (step 408). Next, subtracter 310 takes the difference between the first DWT and the second DWT (step 410). Finally, transmitter 312 transmits the DWT coefficients to video processor 316 for image reconstruction and display (step 412). Note that transmitter 312 may transmit only the larger coefficients, which will reduce bandwidth while maintaining the salient portions of the images as described above. Also note that this is intended to be a continuous process with the third image DWT coefficients being subtracted from the second image DWT coefficients, and so on.

Reconstructing a Data Stream

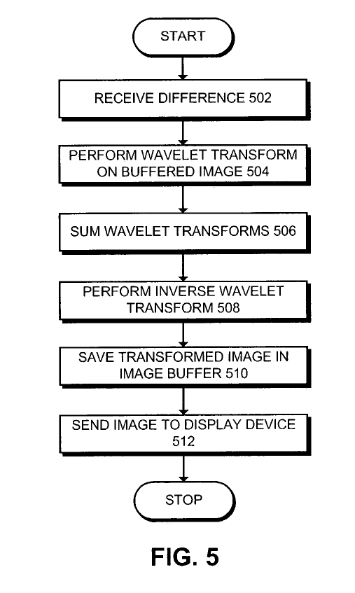

FIG. 5 presents a flowchart illustrating the process of receiving video differences and displaying video images in accordance with an embodiment of the present invention. The system starts when receiver 318 within video processor 316 receives the DWT coefficients from video processor 304 (step 502). Next, wavelet transform 326 performs a DWT on the previous image in image buffer 324 (step 504). Note that this buffered image may be a key frame, or a reconstructed previous frame as described above.

Next, adder 320 sums the DWT coefficients from the previous frame with the DWT coefficients received from video processor 304 (step 506). Inverse transform 322 then performs an inverse DWT on the output of adder 320 to create a reconstructed second image (step 508). Video processor 316 saves this reconstructed image within image buffer 324 (step 510). Finally, video processor 316 sends the reconstructed image to display 328 for display (step 512).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method to facilitate image difference transmission for images in a video system, comprising:
receiving a video stream, wherein the video stream includes a sequence of images;
transforming a first frame of the sequence of images using a transform function to create a first transformed image, wherein the transform function places image salience in larger coefficients;
transforming a second frame using the transform function to create a second transformed image;
subtracting the second transformed image from the first transformed image to create a difference-transformed image; and
removing smaller coefficients from the difference-transformed image, whereby the difference-transformed image can be stored and transmitted with reduced bandwidth while maintaining image salience.

2. The method of claim 1, further comprising:
coupling the difference-transformed image to an image reconstructor;
adding the first transformed image to the difference-transformed image to create a reconstructed transformed image; and
performing an inverse transform function on the reconstructed transformed image to create a reconstructed second frame.

3. The method of claim 2, wherein the reconstructed second frame does not exhibit visual degradation to a human visual system.

4. The method of claim 2, wherein coupling the difference-transformed image to the image reconstructor involves coupling the difference-transformed image through a storage medium.

5. The method of claim 2, wherein coupling the difference-transformed image to the image reconstructor involves coupling the difference-transformed image across a network.

6. The method of claim 5, wherein the network includes the Internet.

7. The method of claim 1, wherein the transform function is a discrete wavelet transform function.

8. The method of claim 1, wherein the sequence of images includes one of a stream of pictures and a stream of three-dimensional renderings.

9. A computer-readable storage medium storing instructions that when executed by a computer cause the computer to perform a method to facilitate image difference transmission for images in a video system, the method comprising:
receiving a video stream, wherein the video stream includes a sequence of images;
transforming a first frame of the sequence of images using a transform function to create a first transformed image, wherein the transform function places image salience in larger coefficients;
transforming a second frame using the transform function to create a second transformed image;
subtracting the second transformed image from the first transformed image to create a difference-transformed image; and
removing smaller coefficients from the difference-transformed image, whereby the difference-transformed image can be stored and transmitted with reduced bandwidth while maintaining image salience.

10. The computer-readable storage medium of claim 9, the method further comprising:
coupling the difference-transformed image to an image reconstructor;
adding the first transformed image to the difference-transformed image to create a reconstructed transformed image; and
performing an inverse transform function on the reconstructed transformed image to create a reconstructed second frame.

11. The computer-readable storage medium of claim 10, wherein the reconstructed second frame does not exhibit visual degradation to a human visual system.

12. The computer-readable storage medium of claim 10, wherein coupling the difference-transformed image to the image reconstructor involves coupling the difference-transformed image through a storage medium.

13. The computer-readable storage medium of claim 10, wherein coupling the difference-transformed image to the image reconstructor involves coupling the difference-transformed image across a network.

14. The computer-readable storage medium of claim 13, wherein the network includes the Internet.

15. The computer-readable storage medium of claim 9, wherein the transform function is a discrete wavelet transform function.

16. The computer-readable storage medium of claim 9, wherein the sequence of images includes one of a stream of pictures and a stream of three-dimensional renderings.

17. An apparatus to facilitate image difference transmission for images in a video system, comprising:
a receiving mechanism that is configured to receive a video stream, wherein the video stream includes a sequence of images;
a transforming mechanism that is configured to transform a first frame of the sequence of images using a transform function to create a first transformed image, wherein the transform function places image salience in larger coefficients;
wherein the transforming mechanism is further configured to transform a second frame using the transform function to create a second transformed image;
a subtracting mechanism that is configured to subtract the second transformed image from the first transformed image to create a difference-transformed image; and
a removing mechanism that is configured to remove smaller coefficients from the difference-transformed image, whereby the difference-transformed image can be stored and transmitted with reduced bandwidth while maintaining image salience.

18. The apparatus of claim 17, further comprising:
a coupling mechanism that is configured to couple the difference-transformed image to an image reconstructor;
an adding mechanism that is configured to add the first transformed image to the difference-transformed image to create a reconstructed transformed image; and
an inverse transform mechanism that is configured to perform an inverse transform function on the reconstructed transformed image to create a reconstructed second frame.

19. The apparatus of claim 18, wherein the reconstructed second frame does not exhibit visual degradation to a human visual system.

20. The apparatus of claim 18, wherein coupling the difference-transformed image to the image reconstructor involves coupling the difference-transformed image through a storage medium.

21. The apparatus of claim 18, wherein coupling the difference-transformed image to the image reconstructor involves coupling the difference-transformed image across a network.

22. The apparatus of claim 21, wherein the network includes the Internet.

23. The apparatus of claim 17, wherein the transform function is a discrete wavelet transform function.

24. The apparatus of claim 17, wherein the sequence of images includes one of a stream of pictures and a stream of three-dimensional renderings.
